(19) United States
(12) Patent Application Publication
(10) Pub. No.: US 2016/0364698 A1
(43) Pub. Date: Dec. 15, 2016

(54) CONFLICT MANAGEMENT FOR CALENDAR EVENTS

(71) Applicant: International Business Machines Corporation, Armonk, NY (US)

(72) Inventors: Firas Bouz, Lexington, KY (US); William J. Hladik, JR., Harrisburg, NC (US)

(21) Appl. No.: 15/098,764

(22) Filed: Apr. 14, 2016

Related U.S. Application Data
(63) Continuation of application No. 14/739,293, filed on Jun. 15, 2015.

(51) Int. Cl. G06Q 10/10

(52) U.S. Cl. CPC G06Q 10/1095

(57) ABSTRACT

Conflict management for calendar events is provided. A schedule of a user has one or more schedule entries, each corresponding to an event that the user is available to attend. A waitlist of the user has one or more waitlist entries, each corresponding to an event that the user is unavailable to attend. Whether the user is available to attend a new event is determined based, at least in part, on a priority of the new event and the one or more schedule entries. A new entry is added to one of the waitlist and the schedule based, at least in part, on whether the user is available to attend the new event. A change in user availability is identified for at least one time period and, in response, an availability determination is updated for an event that at least partially coincides with the at least one time period.

### TECHNICAL FIELD

The present invention relates generally to the field of calendaring systems and more particularly to conflict management for calendar events.

### BACKGROUND OF THE INVENTION

Calendaring systems and software allow a user to schedule events to occur on a certain date at a certain time. Generally, the event can be associated with a textual description of the event. The calendar software may integrate with email software to allow a user to add an event to the calendar by accepting an emailed invitation to the event, in response to which the calendar software adds the event to the calendar.

### SUMMARY

According to one embodiment of the present invention, a method for conflict management for calendar events is provided. The method includes: receiving, by one or more processors, a schedule of a user, the schedule having one or more schedule entries, wherein each schedule entry corresponds to an event that the user is available to attend; receiving, by one or more processors, a waitlist of the user, the waitlist having one or more waitlist entries, wherein each waitlist entry corresponds to an event that the user is unavailable to attend; determining, by one or more processors, whether the user is available to attend a new event based, at least in part, on a priority of the new event and on the one or more schedule entries; adding, by one or more processors, a new entry to one of the waitlist and the schedule based, at least in part, on whether the user is available to attend the new event; and identifying, by one or more processors, a change in user availability for at least one time period and, in response, updating an availability determination for an event that at least partially coincides with the at least one time period.

According to another embodiment of the present invention, a computer program product for conflict management for calendar events is provided. The computer program product comprises a computer readable storage medium and program instructions stored on the computer readable storage medium. The program instructions include: program instructions to receive a schedule of a user, the schedule having one or more schedule entries, wherein each schedule entry corresponds to an event that the user is available to attend; program instructions to receive a waitlist of the user, the waitlist having one or more waitlist entries, wherein each waitlist entry corresponds to an event that the user is unavailable to attend; program instructions to determine whether the user is available to attend a new event based, at least in part, on a priority of the new event and on the one or more schedule entries; program instructions to add a new entry to one of the waitlist and the schedule based, at least in part, on whether the user is available to attend the new event; and program instructions to identify a change in user availability for at least one time period and, in response, update an availability determination for an event that at least partially coincides with the at least one time period.

According to another embodiment of the present invention, a computer system for conflict management for calendar events is provided. The computer system includes one or more computer processors, one or more computer readable storage media, and program instructions stored on the computer readable storage media for execution by at least one of the one or more processors. The program instructions include: program instructions to receive a schedule of a user, the schedule having one or more schedule entries, wherein each schedule entry corresponds to an event that the user is available to attend; program instructions to receive a waitlist of the user, the waitlist having one or more waitlist entries, wherein each waitlist entry corresponds to an event that the user is unavailable to attend; program instructions to determine whether the user is available to attend a new event based, at least in part, on a priority of the new event and on the one or more schedule entries; program instructions to add a new entry to one of the waitlist and the schedule based, at least in part, on whether the user is available to attend the new event; and program instructions to identify a change in user availability for at least one time period and, in response, update an availability determination for an event that at least partially coincides with the at least one time period.

### BRIEF DESCRIPTION OF THE DRAWINGS

FIG. 1 is a functional block diagram illustrating a computing environment, in accordance with an embodiment of the present invention.

FIG. 2 is a flowchart depicting operations for conflict management for calendar events, on a computing device within the computing environment of FIG. 1, in accordance with an embodiment of the present invention.

FIG. 3 is a flowchart depicting operations for conflict management for calendar events, on a computing device within the computing environment of FIG. 1, in accordance with an embodiment of the present invention.

FIG. 4 is a flowchart depicting operations for conflict management for calendar events, on a computing device within the computing environment of FIG. 1, in accordance with an embodiment of the present invention.

FIG. 5 is a block diagram of components of a computing device executing operations for conflict management for calendar events, in accordance with an embodiment of the present invention.

### DETAILED DESCRIPTION

Embodiments of the present invention recognize that software calendar programs allow a user to manage a schedule. Calendar programs allow a user to schedule events on a calendar. Each such event corresponds to a specific date and time. A user may schedule an event manually or by accepting an invitation to the event. If the user declines the invitation, the event is not scheduled on the calendar. Further recognized is that, in some cases, a calendar program allows a user to automatically accept invitations to events for which the user is available and automatically decline invitations to events for which the user is unavailable. In other cases, the calendar program accepts or declines an invitation based on input received from the user. Embodiments of the present invention also recognize that the availability of a user may change. For example, a user may become available for a future event for which the user was previously unavailable. In another example, the user may become unavailable for a future event for which the user was previously available.

Embodiments of the present invention provide for conflict management for calendar events. Some embodiments provide for modifying a schedule of a user based on a change in the availability of the user. Further, some embodiments provide for modifying a schedule of a user by updating an availability determination for an event. Further, some embodiments provide for updating the availability of a user for an event in response to changes in event details of an event. An invitation can be accepted if the user is available for the new event. The response to the invitation can be modified to decline the invitation if the user becomes unavailable for the new event. Similarly, a declined invitation to an event can be accepted if the user subsequently becomes available for the event.

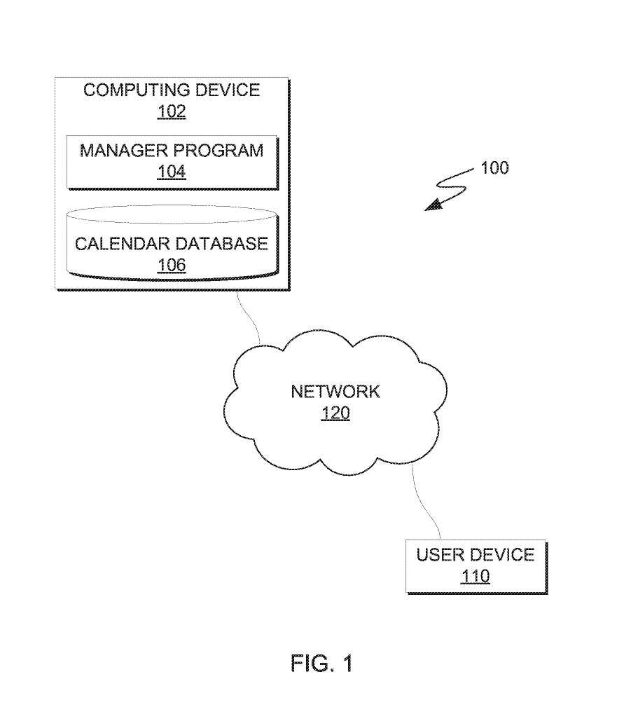

Embodiments of the present invention will now be described in detail with reference to the Figures. FIG. 1 is a functional block diagram illustrating a computing environment, in accordance with an embodiment of the present invention. For example, FIG. 1 is a functional block diagram illustrating computing environment 100. Computing environment 100 includes computing device 102 and user device 110 connected over network 120. Computing device 102 includes manager program 104 and calendar database 106.

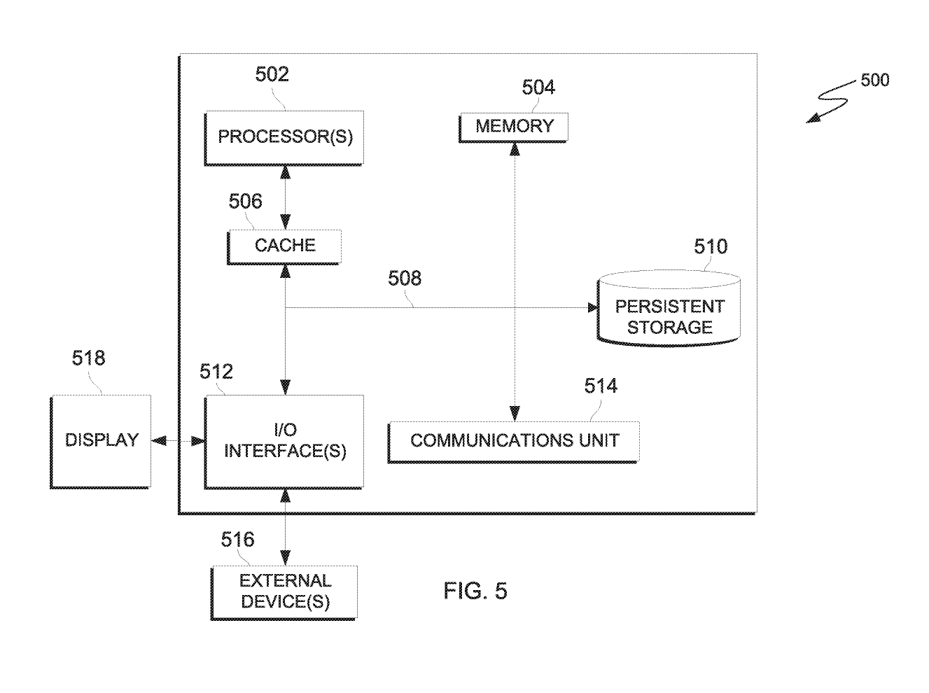

In various embodiments, computing device 102 is a computing device that can be a standalone device, a server, a laptop computer, a tablet computer, a netbook computer, a personal computer (PC), or a desktop computer. In another embodiment, computing device 102 represents a computing system utilizing clustered computers and components to act as a single pool of seamless resources. In general, computing device 102 can be any computing device or a combination of devices with access to user device 110 and with access to and/or capable of executing manager program 104 and calendar database 106. Computing device 102 may include internal and external hardware components, as depicted and described in further detail with respect to FIG. 5.

In this embodiment, manager program 104 and calendar database 106 are stored on computing device 102. In other embodiments, one or both of manager program 104 and calendar database 106 may reside on another computing device, provided that each can access and is accessible by each other. In yet other embodiments, one or both of manager program 104 and calendar database 106 may be stored externally and accessed through a communication network, such as network 120. Network 120 can be, for example, a local area network (LAN), a wide area network (WAN) such as the Internet, or a combination of the two, and may include wired, wireless, fiber optic or any other connection known in the art. In general, network 120 can be any combination of connections and protocols that will support communications between computing device 102 and user device 110, in accordance with a desired embodiment of the present invention.

As used herein, a “number” of one or more items means the count or tally of how many items are in the one or more items.

Manager program 104 operates to manage conflicts for calendar events. In various embodiments, manager program 104 receives an update to a user availability, determines a change in availability for a user for one or more events, generates one or more change notifications, and updates a calendar of a user. In various embodiments, manager program 104 receives an invitation to an event, identifies conflicting schedule entries on a schedule of a user, and determines whether a priority of the event of the invitation exceeds a priority of each conflicting schedule entry. In some embodiments, manager program 104 receives a change to the event details of an event and, in response, manager program 104 updates an availability of a user for one or more events.

Calendar database 106 is a data repository that may be written to and read by manager program 104. Calendar data may be stored to calendar database 106. In some embodiments, calendar database 106 may be written to and read by user device 110 or by programs and entities outside of computing environment 100 in order to populate the repository with calendar data.

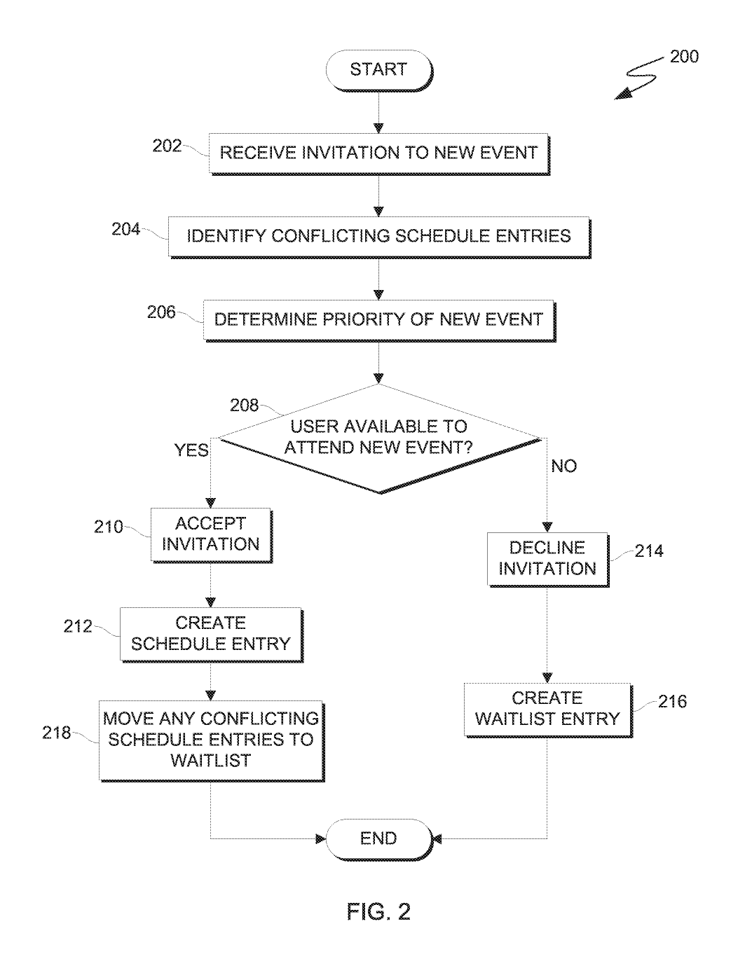

Calendar data includes a calendar of a user, which includes a schedule and a waitlist. The schedule is a data structure that organizes one or more schedule entries. The waitlist is a data structure that organizes one or more waitlist entries. The terms “schedule entry” and “waitlist entry” are terms of convenience used to refer to entries included in the schedule or the waitlist, respectively. An entry is a data structure that corresponds to an event. The entry includes event details and a response log. The event details describe an event corresponding to the entry. Event details are discussed further, for example, in connection with FIG. 2. The response log includes one or more availability determinations. An availability determination indicates whether the user is available to attend the event. A change in the schedule of the user may affect the availability of the user to attend an event. In one embodiment, the response log may include multiple availability determinations corresponding to different points in time. Manager program 104 generates an availability determination in response to determining whether the user is available to attend an event, as discussed further, for example, in connection with FIG. 2.

In one embodiment, a schedule entry corresponds to an event for which the user is available and that the user is scheduled to attend. In another embodiment, a schedule entry may correspond to a period of unavailability of the user. For example, a user may specify a period of unavailability during a vacation, time out of the office, or other period of time. Waitlist entries correspond to events to which the user is not scheduled to attend. For example, a waitlist entry may correspond to an event for which the user is unavailable due to a conflicting schedule entry having a priority higher than a priority of the waitlist entry. The conflicting schedule entry may correspond to an event or to a period of unavailability specified by the user. For example, manager program 104 may determine that a user is available for an event and, in response, create a schedule entry by adding an entry to the schedule that includes event details describing the event and a response log indicating that the user is scheduled to attend the event.

In some embodiments, a schedule entry corresponds to a period of limited availability. The period of limited availability includes one or more criteria. Manager program 104 treats the period of limited availability as a period of unavailability for all entries that fail to meet the criteria. In one embodiment, manager program 104 disregards the period of limited availability with respect to an entry that meets the criteria of the period of limited availability. For example, a user may specify a period of limited availability with criteria specifying a particular mode of attendance (e.g., telephone, internet-based communications) and a particular priority (e.g., 0.8 or higher). In this example, manager program 104 may determine that, during a period of limited availability, a user is available to attend a high-priority conference call, unavailable to attend a high-priority in-person meeting, and unavailable to attend a low-priority webinar.

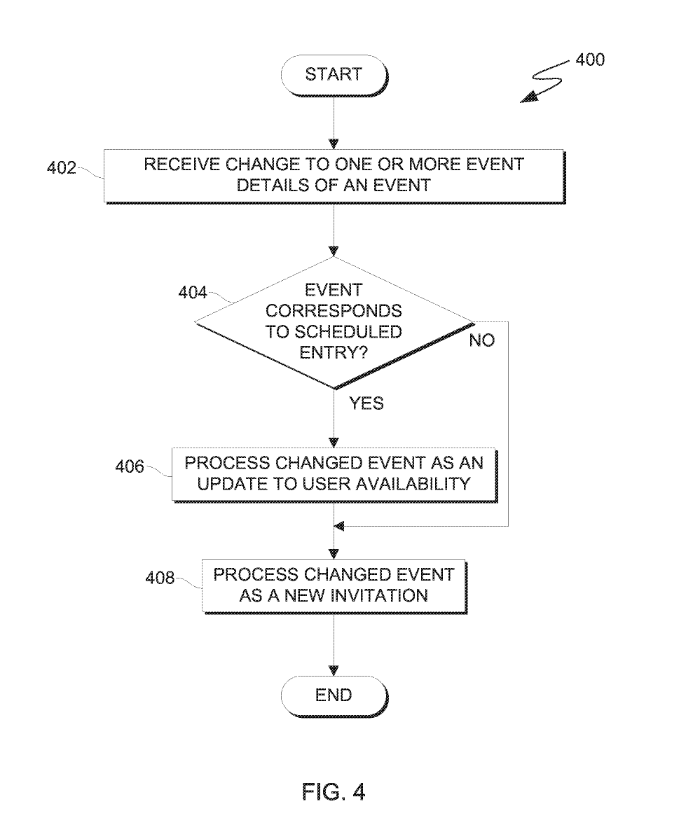

In various embodiments, user device 110 is a computing device that can be a standalone device, a server, a laptop computer, a tablet computer, a netbook computer, a personal computer (PC), a desktop computer, a personal digital assistant (PDA), a smart phone, or any programmable electronic device capable of communicating with computing device 102 via network 120. In another embodiment, user device 110 represents a computing system utilizing clustered computers and components to act as a single pool of seamless resources. In general, user device 110 can be any computing device or a combination of devices with access to computing device 102, and with access to and/or capable of executing some or all of manager program 104 and calendar database 106. In some embodiments, user device 110 includes a user interface (UI) by which a user provides user input to user device 110. User device 110 can communicate such user input, via network 120, to computing device 102. User device 110 may include internal and external hardware components, as depicted and described in further detail with respect to FIG. 4.

FIG. 2 is a flowchart depicting operations for conflict management for calendar events, on a computing device within the computing environment of FIG. 1, in accordance with an embodiment of the present invention. For example, FIG. 2 is a flowchart depicting operations 200 of manager program 104 on computing device 102 within computing environment 100.

In operation 202, manager program 104 receives an invitation for a new event. The invitation includes event details describing the new event. Event details of an event include at least a start time of the event and an end time of the event. The start time is a date and time at which the event begins. The end time is a date and time at which the event ends. The end time is equal to or later than the start time. The entry and the event each correspond to a time period starting with a start time and ending with an end time. The amount of time between the start time of an event and the end time of the event is the duration of the event. The duration of an event may be zero (i.e., if the start time equals the end time) or more. In various embodiments, manager program 104 receives the invitation as user input, from user device 110, from a source external to computing environment 100, or from calendar database 106.

In various embodiments, event details may also include one or more of: a reply address, an attendance method, a location, an attendance requirement, and an event description. The reply address is an electronic communications address (e.g., an email address, network address, or uniform resource identifier) designated to receive a response to the invitation for the event. The response indicates whether the user is scheduled to attend the event. The attendance method identifies the manner in which the user attends or accesses the event (e.g., in person, via webinar, via phone). The attendance requirement identifies how important it is that the user attends the event. In various examples, the attendance requirement indicates that attendance by the user is mandatory (i.e., attendance is required), optional (i.e., attendance is requested but not required), or permissible (i.e., the user is notified of the event but attendance is not requested or required). One of ordinary skill will understand that the user may be unable or unwilling to attend an event regardless of the attendance requirement, even if attendance by the user is mandatory. The event description may include text or other materials describing the event, such as, for example, a subject, a chairperson or host, presentation documentation, or other materials. The event details of an entry may include a priority, which is discussed further below.

In some embodiments, manager program 104 receives an indication of interest in attending the event from the user. For example, the user provides user input by interacting with user interface elements (e.g., “accept” or “decline” buttons presented via an email or calendaring program), thereby expressing interest or disinterest in attending the new event. If the user indicates disinterest in attending the new event, then manager program 104 declines the invitation (see operation 214). In one embodiment, manager program 104 creates a waitlist entry for the new event (see operation 216). In this case, the waitlist entry includes the indication of interest received from the user. In another embodiment, manager program 104 ceases operations 200 for the invitation to the new event, thereby disregarding the invitation from further processing. If the user indicates interest in attending the new event, then manager program 104 continues operations 200 by identifying any conflicting schedule entries (see operation 204). Thus, in some embodiments, manager program 104 performs operations 200 only if the user indicates interest in attending the event. In other embodiments, manager program 104 performs operations 200 irrespective of any indication of interest.

In some embodiments, the indication of interest includes additional categories. In one such embodiment, a user interface element (e.g., a “tentative” button) corresponds to a tentative interest in attending the new event. If the user indicates tentative interest in attending the new event, then manager program 104 processes the new event as though the user had expressed interest in attending the event. However, if manager program 104 determines that the user is available to attend the event, the generated response indicates that the user tentatively accepts the invitation to the new event. Manager program 104 may change the indication of interest in response to receiving subsequent user input. For example, manager program 104 may receive user input changing a tentative indication to an acceptance.

In operation 204, manager program 104 identifies any conflicting schedule entries. As discussed previously, the schedule of the user is stored in calendar database 106 and may include one or more schedule entries. In one embodiment, manager program 104 identifies conflicting schedule entries based on the start time and the end time of the new event and further based on the schedule of the user. The conflicting schedule entry corresponds to either an event or to a period of unavailability. A conflicting schedule entry is a schedule entry that at least partially coincides with the new event. A first event at least partially coincides with a second event if one of the following two conditions are true: first, if the start time of the first event is greater than or equal to the start time of the second event and is less than the end time of the second event; or, second, if the end time of the first event is less than or equal to the end time of the second event and is greater than the start time of the second event. A first event completely coincides with a second event if the start and end times of the first event equal the start and end times of the second event.

In operation 206, manager program 104 determines a priority of the new event. The priority is a value along a scale (e.g., zero to one) that reflects the importance of the event. In some embodiments, manager program 104 determines a priority of an event by aggregating one or more sub-scores, wherein manager program 104 determines each sub-score based on an event detail of the event. The priority of an entry is the priority of the event to which the entry corresponds. In various examples, the priority is an average, a weighted average, or other statistical aggregation of the determined sub-scores. In one such embodiment, each possible value of an event detail maps to a sub-score value, which impacts the aggregated priority. For example, a priority for an event having an attendance requirement of mandatory may be higher than a priority for an event having an attendance requirement of optional, which would be higher than a priority for an event having an attendance requirement of permissible. In another example, manager program 104 may determine a sub-score based on a relationship between the user and a chairperson, host, or presenter of an event. In this case, manager program 104 may determine a higher priority for an event hosted by a supervisor of the user than for an event hosted by someone unrelated to the user.

In some embodiments, manager program 104 determines the priority for an event based on a sub-score for some or all of the event details of an event. For example, manager program 104 may determine a sub-score for the attendance requirement but not for the subject of the event. In one embodiment, manager program 104 receives user input identifying the event details for which manager program 104 determines sub-scores. In another embodiment, manager program 104 determines sub-scores for a predetermined set of event details.

In some embodiments, manager program 104 determines a priority based on a predetermined value or, in other embodiments, based on user input. For example, a user may specify a priority for a particular event. In another embodiment, manager program 104 determines the priority for an entry corresponding to a period of unavailability based on a predetermined value. For example, manager program 104 determines that an entry corresponds to a period of unavailability and, in response, determines a priority of the entry based on a user-specified value corresponding to periods of unavailability.

In decision 208, manager program 104 determines whether the user is available to attend the new event. In one embodiment, manager program 104 determines whether the user is available based on the conflicting schedule entries (if any) identified in operation 204, the priority of any such conflicting schedule entries, and the priority of the new event determined in operation 206. Manager program 104 determines that the user is available (decision 208, YES branch) if there are no conflicting schedule entries. If there are one or more conflicting schedule entries, manager program 104 determines whether the user is available further based on the priorities of the new event and the priorities of the conflicting schedule entries. Manager program 104 determines that the user is available (decision 208, YES branch) if the priority of the new event is higher than the priority of the conflicting schedule entries. Manager program 104 determines that the user is not available (decision 208, NO branch) if the priority of the new event is less than or equal to the priority of at least one of the conflicting schedule entries. If manager program 104 determines that the user is available (decision 208, YES branch), then manager program 104 accepts the invitation (operation 210). If manager program 104 determines that the user is not available (decision 208, NO branch), then manager program 104 declines the invitation (operation 214). Manager program 104 generates an availability determination that reflects the determination of whether the user is available to attend the new event.

In operation 210, manager program 104 accepts the invitation to the new event. Manager program 104 accepts an invitation by generating a response to the invitation that indicates that the user is available to attend the new event.

In some embodiments, manager program 104 initiates sending the generated response (e.g., via network 120) to the reply address identified by the event details of the invitation. For example, manager program 104 determines that a user is available to attend a new event identified by an invitation and, in response, manager program 104 initiates sending the generated response via email to an address specified by the reply address of the event details of the invitation, wherein the email indicates the generated response. In another example, manager program 104 initiates sending the generated response by updating a status value in a repository (e.g., a group calendar) available at a network address specified by the reply address, wherein the status value corresponds to the user and the event.

In operation 212, manager program 104 creates a schedule entry. The schedule entry includes event details for the new event based on the event details of the received invitation. The schedule entry also includes a response log containing at least an availability determination indicating that the user is available to attend the new event. Manager program 104 modifies the schedule to include the schedule entry, which includes the event details and the response log.

In operation 214, manager program 104 declines the invitation received in operation 202. Manager program 104 declines an invitation by generating a response to the invitation that indicates that the user is not available to attend the new event.

In some embodiments, manager program 104 initiates sending the generated response (e.g., via network 120) to the reply address identified by the event details of the invitation. For example, manager program 104 determines that a user is not available to attend a new event identified by an invitation and, in response, manager program 104 initiates sending the response via email to an address specified by the reply address of the event details of the invitation, wherein the email indicates the generated response. In another example, manager program 104 initiates sending the generated response by updating a status value in a repository (e.g., a group calendar) available at a network address specified by the reply address, wherein the status value corresponds to the user and the event.

In operation 216, manager program 104 creates a waitlist entry. The waitlist entry includes event details for the new event based on the event details of the received invitation. The waitlist entry also includes a response log containing at least an availability determination that indicates that the user is not available to attend the new event. Manager program 104 modifies the waitlist to include the waitlist entry, which includes the event details and the response log.

In operation 218, manager program 104 moves any conflicting schedule entries identified in operation 204 to the waitlist. In one embodiment, manager program 104 identifies no conflicting schedule entries in operation 204, in which case manager program 104 may skip operation 218. In another embodiment, manager program 104 identifies one or more conflicting schedule entries having a priority less than the new event, in which case manager program 104 moves each conflicting schedule entry to the waitlist.

In one embodiment, manager program 104 moves an entry from a source (e.g., the schedule or the waitlist) to a destination (e.g., the other of the schedule or the waitlist) by modifying the source to no longer include the entry and modifying the destination to include the entry. For example, manager program 104 may remove a pointer or other reference from the source and add a pointer or reference to the destination, wherein the pointer or reference points or refers to the entry being moved. In another embodiment, manager program 104 moves an entry by copying data (e.g., event details, response log) from one of the schedule and the waitlist to the other of the schedule and the waitlist.

In some embodiments, manager program 104 identifies one or more changes to user availability based on removing a conflicting schedule entry from the schedule and adding a new entry to the schedule. In one example, a user becomes unavailable during any times corresponding to the new event that do not correspond to the conflicting schedule entry. In another example, the user becomes available during any times corresponding to the conflicting schedule entry that do not correspond to the new event. In one embodiment, manager program 104 generates an update to user availability for each change to the user availability based on the new event and the one or more conflicting schedule entries moved to the waitlist. In another embodiment, manager program 104 generates an update for each change by which the user becomes available, based on the new event and the one or more conflicting schedule entries moved to the waitlist. In other words, manager program 104 identifies a change in user availability if one, but not both, of the start time and the end time of a conflicting schedule entry occurs during the new event. Manager program 104 may perform operations 300 for each such generated update to user availability.

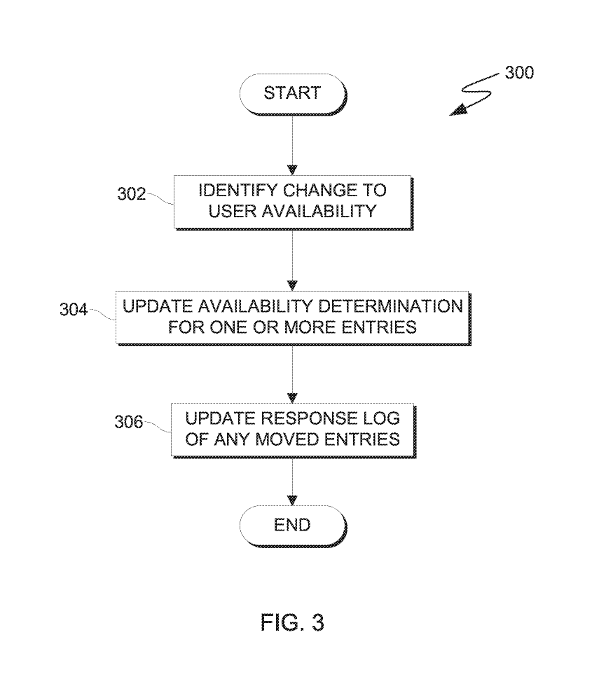

FIG. 3 is a flowchart depicting operations for conflict management for calendar events, on a computing device within the computing environment of FIG. 1, in accordance with an embodiment of the present invention. For example, FIG. 3 is a flowchart depicting operations 300 of manager program 104 on computing device 102 within computing environment 100.

In operation 302, manager program 104 identifies a change to user availability. A change to user availability is a modification to the schedule of the user during a specified time period. For example, a user may become unavailable during a time period based on a user input specifying a period of unavailability for a planned vacation day. In another example, a user may become available during a time period based on manager program 104 moving a conflicting schedule entry to the waitlist in response to receiving an invitation for a new event having higher priority (see FIG. 2 and accompanying discussion).

In operation 304, manager program 104 updates an availability determination for one or more entries. Manager program 104 identifies one or more entries to update based on the time period specified by the change in availability and based on whether the user became available or unavailable during the specified time period.

In some embodiments, manager program 104 determines, based on the change to user availability, that the user has become available during a specified time period. In this case, manager program 104 determines whether the user is available to attend one or more waitlist entries in light of the change in availability. For example, manager program 104 determines whether a waitlist entry occurs completely within available time, which includes the time period specified by the change in availability and any time periods adjacent to the specified time period during which the user is available. If manager program 104 determines that a user is available for a waitlist entry, then manager program 104 moves the waitlist entry to the schedule. If manager program 104 determines that the user is available for multiple waitlist entries, then manager program 104 selects waitlist entries in descending order of priority and subject to the restriction that selected waitlist entries cannot partially or completely coincide.

In other embodiments, manager program 104 determines, based on the change to user availability, that the user has become unavailable during a specified time period. In this case, manager program 104 determines the one or more entries to update by identifying schedule entries that at least partially coincide with the specified time period. In one such embodiment, manager program 104 processes the period of unavailability specified by the change in a manner similar to an invitation (see FIG. 2 and accompanying discussion). For example, manager program 104 may determine whether to accept or decline the change to user availability based on a determined priority of the period of unavailability and the priority of each of the one or more entries identified in this operation 304. In another such embodiment, manager program 104 moves all identified schedule entries to the waitlist, irrespective of the priority of the identified schedule entries.

In operation 306, manager program 104 updates a response log of the moved entries, if any. If manager program 104 moves an entry from the waitlist to the schedule, then manager program 104 updates the response log of the entry with a new availability determination indicating that the user is available to attend the event to which the entry corresponds. If manager program 104 moves an entry from the schedule to the waitlist, then manager program 104 updates the response log of the entry with a new availability determination indicating that the user is unavailable to attend the event to which the entry corresponds. In some embodiments, manager program 104 appends the new availability determination to the response log. In other embodiments, manager program 104 replaces the availability determination in the response log with the new availability determination. In yet other embodiments, manager program 104 adds the new availability determination to the response log with one or more of a timestamp and an indication of the basis of the availability determination. For example, if manager program 104 moves a schedule entry to the waitlist in response to receiving an invitation to a higher priority event, manager program 104 updates the response log of the moved schedule entry to identify the higher priority event.

In some embodiments, manager program 104 generates a response for each event having an updated availability determination. The response indicates the updated availability decision. In some embodiments, manager program 104 initiates sending the generated response responsive to generating the response. In other embodiments, manager program 104 initiates sending the generated response based on a time delay. In various embodiments, manager program 104 initiates sending the generated response responsive to: determining that a predetermined duration of time has elapsed since manager program 104 received the invitation to the new event; determining that a predetermined duration of time has elapsed since manager program 104 generated the response; determining that the time remaining until the start time of the event is below a predetermined threshold; or any combination thereof. For example, manager program 104 initiates sending the generated response in response to determining that one week remains until the date of the start time of the event, which avoids unnecessary network traffic in the event of multiple changes in user availability for the event prior to initiating sending the generated response. In some embodiments, manager program 104 initiates sending the generated response (e.g., via network 120) to the reply address identified by the event details of the invitation.

FIG. 4 is a flowchart depicting operations for conflict management for calendar events, on a computing device within the computing environment of FIG. 1, in accordance with an embodiment of the present invention. For example, FIG. 4 is a flowchart depicting operations 400 of manager program 104 on computing device 102 within computing environment 100.

In operation 402, manager program 104 receives a change to one or more event details of an event. Manager program 104 writes the updated event details to the entry corresponding to the event. In one embodiment, manager program 104 identifies the entry corresponding to the event being changed based on a unique identifier included in the event details of the entry and in the received change. In another embodiment, manager program 104 identifies the event by matching event details of the entry with event details of the received change.

In some embodiments, the updated event details include a change to a time period of the event. In various examples, updated event details include a modified start time, modified end time, or both. A change to a time period of an event may occur in connection with, for example, rescheduling the event, canceling the event, or otherwise modifying the time period of the entry corresponding to the event. In other embodiments, the updated event details modify one or more other event details. For example, the updated event details may modify an event description, subject, reply address, attendance requirement, or any other event detail.

In some embodiments, manager program 104 determines that the changes to the event details do not affect the priority of the event or the time period of the event, in which case manager program 104 skips decision 404, operation 406, and operation 408. In one embodiment, manager program 104 determines whether the changes to the event details affect the priority of the event based on whether the priority of the event is based, at least in part, on the event detail, as described further in connection with, for example, operation 206.

In decision 404, manager program 104 determines whether the event corresponds to a schedule entry. The entry is either a schedule entry or a waitlist entry. Manager program 104 determines whether the event is a schedule entry based on whether the schedule includes the entry. If manager program 104 determines that the entry is a schedule entry (decision 404, YES branch), then manager program 104 processes the changed entry as an update to user availability (operation 406). If manager program 104 determines that the entry is not a schedule entry (decision 404, NO branch), then manager program 104 processes the changed entry as a new invitation (operation 408).

In operation 406, manager program 104 processes the changed entry as an update to user availability. Manager program 104 processes the changed entry as an update to user availability by performing operations 300 based on the change to the time period of the event. For example, an event rescheduled from a first day to a second day creates availability during a time period on the first day. In this case, manager program 104 processes the changed entry as an update to user availability to determine whether this change makes the user available for any waitlist entries.

In operation 408, manager program 104 processes the changed entry as a new invitation. Manager program 104 processes the changed entry as a new invitation by performing operations 300, treating the changed entry as a new event that the user is invited to attend. For example, manager program 104 processes an event rescheduled from a first day to a second day as though manager program 104 received an invitation to the event using the time period of the second day. In some embodiments, manager program 104 skips operation 408 if manager program 104 determines that the change shortens the duration of the time period by changing one, but not both, of the start time and the end time. In some embodiments, manager program 104 skips operation 408 if manager program 104 determines that the event is canceled (e.g., by the event organizer, by the user, or by another).

In some embodiments, manager program 104 includes additional functionality. In one embodiment, manager program 104 interfaces with a voicemail function of a user. For example, manager program 104 may update a voicemail greeting of the user with a voice message that indicates one or more time periods during which the user is available or unavailable. Manager program 104 may update the voicemail greeting in response to changes to user availability. In another embodiment, manager program 104 interfaces with an email function to update an email signature of the user to indicate one or more time periods during which the user is available or unavailable. In another embodiment, manager program 104 generates one or more reports for a user providing a summary of received emails, thereby enabling the user to manually respond to one or more of the received emails or alter update actions manager program 104 performs. For example, manager program 104 may be instructed to archive, tag, or group all incoming emails received during a period of unavailability. In another embodiment, manager program 104 declines invitations to new events received during a period of unavailability with an unavailability message as a comment. For example, manager program 104 may automatically generate the unavailability message based on the event details of the period of unavailability.

FIG. 5 is a block diagram of components of a computing device, generally designated 500, in accordance with an embodiment of the present invention. In one embodiment, computing system 500 is representative of computing device 102 within computing environment 100, in which case computing device 102 includes manager program 104 and calendar database 106.

It should be appreciated that FIG. 5 provides only an illustration of one implementation and does not imply any limitations with regard to the environments in which different embodiments may be implemented. Many modifications to the depicted environment may be made.

Computing system 500 includes processor(s) 502, cache 506, memory 504, persistent storage 510, input/output (I/O) interface(s) 512, communications unit 514, and communications fabric 508. Communications fabric 508 provides communications between cache 506, memory 504, persistent storage 510, communications unit 514, and input/output (I/O) interface(s) 512. Communications fabric 508 can be implemented with any architecture designed for passing data and/or control information between processors (such as microprocessors, communications and network processors, etc.), system memory, peripheral devices, and any other hardware components within a system. For example, communications fabric 508 can be implemented with one or more buses or a crossbar switch.

Memory 504 and persistent storage 510 are computer readable storage media. In this embodiment, memory 504 includes random access memory (RAM). In general, memory 504 can include any suitable volatile or non-volatile computer readable storage media. Cache 506 is a fast memory that enhances the performance of processor(s) 502 by holding recently accessed data, and data near recently accessed data, from memory 504.

Program instructions and data used to practice embodiments of the present invention may be stored in persistent storage 510 and in memory 504 for execution by one or more of the respective processor(s) 502 via cache 506. In an embodiment, persistent storage 510 includes a magnetic hard disk drive. Alternatively, or in addition to a magnetic hard disk drive, persistent storage 510 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 510 may also be removable. For example, a removable hard drive may be used for persistent storage 510. Other examples include optical and magnetic disks, thumb drives, and smart cards that are inserted into a drive for transfer onto another computer readable storage medium that is also part of persistent storage 510.

Communications unit 514, in these examples, provides for communications with other data processing systems or devices. In these examples, communications unit 514 includes one or more network interface cards. Communications unit 514 may provide communications through the use of either or both physical and wireless communications links. Program instructions and data used to practice embodiments of the present invention may be downloaded to persistent storage 510 through communications unit 514.

I/O interface(s) 512 allows for input and output of data with other devices that may be connected to each computer system. For example, I/O interface(s) 512 may provide a connection to external device(s) 516 such as a keyboard, keypad, a touch screen, and/or some other suitable input device. External device(s) 516 can also include portable computer readable storage media such as, for example, thumb drives, portable optical or magnetic disks, and memory cards. Software and data used to practice embodiments of the present invention can be stored on such portable computer readable storage media and can be loaded onto persistent storage 510 via I/O interface(s) 512. I/O interface(s) 512 also connect to display 518.

Display 518 provides a mechanism to display or present data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The term(s) “Smalltalk” and the like may be subject to trademark rights in various jurisdictions throughout the world and are used here only in reference to the products or services properly denominated by the marks to the extent that such trademark rights may exist.

The term “exemplary” means of or relating to an example and should not be construed to indicate that any particular embodiment is preferred relative to any other embodiment.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for conflict management for calendar events, the method comprising:
receiving, by the one or more processors, a schedule of a user, the schedule having one or more schedule entries, wherein each schedule entry corresponds to an event that the user is available to attend;
receiving, by the one or more processors, a waitlist of the user, the waitlist having one or more waitlist entries, wherein each waitlist entry corresponds to an event that the user is unavailable to attend;
receiving, by the one or more processors, an invitation to a new event;
determining, by the one or more processors, that a time period of the new event at least partially coincides with a time period of a first schedule entry of the one or more schedule entries;
in response to determining that the time period of the new event at least partially coincides with the time period of the first scheduled entry of the one or more scheduled entries, determining, by the one or more processors, the priority of the new event based on an aggregation of one or more sub-scores comprising a first sub-score determined based on a relationship between the user and an individual associated with the new event and a second sub-score determined based on an attendance requirement of the user;
determining, by the one or more processors, whether the priority of the new event exceeds a priority of the first schedule entry;
in response to determining that the priority of the new event exceeds the priority of the first scheduled entry:
determining, by the one or more processors, that the user is available to attend the new event;
updating, by the one or more processors, an availability determination of the user for the first schedule entry to indicate that the user is unavailable to attend the first schedule entry;
moving, by the one or more processors, the first schedule entry from the schedule to the waitlist; and
creating, by the one or more processors, a new entry in the schedule based on the new event;
in response to determining that the priority of the new event is less than the priority of the first scheduled entry:
determining, by the one or more processors, that the user is unavailable to attend the new event; and
creating, by the one or more processors, a new entry in the waitlist based on the new event;
generating, by the one or more processors, a first response based on a user availability determination for the new event;
initiating to send, by the one or more processors, the first response to a reply address identified by the invitation to the new event;
generating, by the one or more processors, a first voicemail message based on the user availability determination for the new event;
identifying, by the one or more processors, a change in user availability for at least one time period; and
in response to identifying the change in user availability for the at least one time period:
determining, by the one or more processors, an updated availability determination for an event in the waitlist that at least partially coincides with the at least one time period;
generating, by the one or more processors, a second response based on the updated availability determination;
initiating to send, by the one or more processors, the second response to the reply address; and
generating, by the one or more processors, a second voicemail message based on the updated availability determination.
